(19) United States
(12) Patent Application Publication
(10) Pub. No.: US 2006/0274088 A1
(43) Pub. Date: Dec. 7, 2006

(54) Method for drawing graphics in a web browser or web application

(75) Inventors: Wilbur Leslie Dublin III, Austin, TX (US); David Raymond Pruett, Round Rock, TX (US)

Correspondence Address: TIM COOK, P.O. BOX 10107, LIBERTY, TX, 77575, US

(73) Assignee: NETWORK I/O, INC., Austin, TX (US)

(21) Appl. No.: 11/308,289

(22) Filed: Mar. 15, 2006

Related U.S. Application Data
(60) Provisional application No. 60/686,988, filed on Jun. 4, 2005.

(51) Int. Cl. G09G 5/00

(52) U.S. Cl. 345/660

(57) ABSTRACT

A graphics drawing method minimizes the number of predetermined images required to perform a plot on or within a web browser. A limited number of previously generated images or overlay tools are provided, referred to herein as “image tiles”, which are then tiled and stretched by the user to define the desired graphic. The overlay tools are selected as required to improve image quality.

This application claims the benefit of U.S. Provisional Application Ser. No. 60/686,988 filed Jun. 4, 2005.

### FIELD OF THE INVENTION

The present invention relates generally to the field of graphics functions and, more particularly, to a method of and a system for drawing graphics and the like on a graphical user interface, such as for example in a web browser or other web application.

### BACKGROUND OF THE INVENTION

Many applications today make use of line drawing utilities to display piece-wise continuous functions and other displays within a web browser. For example, remote monitoring of sensed measurements is often displayed on a remote server using a browser function which provides additional functionality. In this way, time-wise single element functions can be displayed. Other applications may call for single or multiple dimension overlays, or multiple element, simultaneous time-wise graphical displays.

Modern web browsers do not generally have any innate drawing ability in themselves. Several browser application environments such as Sun Microsystems' Java or plug-ins such as Macromedia's Flash or any of several SVG plug-ins can give line drawing capabilities to some browsers. However, the use of a plug-in has several drawbacks. First, a plug-in may initially slow down the user while the plug-in loads. Second, requiring the use of a plug-in in certain applications may make certain functions unavailable altogether if the user has not already installed the plug-in needed. Further, not all plug-ins are available for all browsers, or on all operating systems, which can render the function permanently unavailable to certain users. Finally, some plug-ins (such as the various versions of the Java Virtual Machine or Java Runtime Environment) are not entirely compatible from one implementation to the next, making it hard to guarantee correct operation in all environments. If that occurs, the user can only draw lines with the use of standard existing browser capabilities, with the inherent limitations mentioned above.

One well known line drawing technique is commonly referred to as the Bresenham line-drawing algorithm. This algorithm involves stepping from pixel to pixel and is widely used on devices that can draw individual pixels. Unfortunately, the algorithm admittedly involves an error, C, and choice of the next pixel in a step wise fashion typically involves a choice based on an attempt to minimize this error. Even with this recognized drawback, the Bresenham line-drawing algorithm has gained wide acceptance in applications including web browsers because the calculations are relatively simple, and the errors are commonly acceptable for the specific applications.

Another common technique used today in web browsers involves drawing bar charts by stretching single-dimension pixel images into rectangular blocks. This technique tends to produce course and crude-looking graphs. Also, bar charts have a rather limited number of applications, and do not lend themselves to plotting multiple curves in one graph.

The use of “div” elements has been tried to create lines in a manner similar to Bresenham. A “div” element is a rectangular region that can contain image or other HTML content, such as for example a pre-selected group of pixel elements applied to an x-y region of a browser area, typically defining a straight line arrangement of the pixels. Browsers often cannot gracefully handle an excessive number of divs, which this technique tends to generate. Other techniques commonly in use today to draw plots within a browser combine multiple pixels of a line into a single div. A number of examples of these types of techniques are shown and described at www.walterzorn.com, incorporated herein by reference. However, while the download of the program for drawing plots is rather small, the resulting code for the plot itself tends to be quite large, and the number of divs is still also large, because each segment of the plot is often small, and thus each plot requires a large number of small segments.

Thus, there remains a need for a fast, low-resource method for drawing in a web browser or other environment where the drawing can be constructed piecewise from preloaded image fragments. The present invention is directed to filling this need in the art.

### SUMMARY OF THE INVENTION

The present invention provides a method for minimizing the number of images required to perform a plot on or within a web browser. The method includes providing a limited number of previously generated images or overlay tiles, referred to herein as “image tiles”, which are then tiled and stretched by a program, such as for example JavaScript, running in the user's web browser, thereby defining the desired plot. The overlay tiles are selected as required to improve image quality.

The method of this invention further provides a method for performing such drawing in any color or set of colors, using only a small set of “master” drawing images. The invention also minimizes the size and number of image tiles required to draw a graph, display, or annotation. This technique minimizes both the required memory storage and computation requirements of the web server, allowing a graphics engine based on these principles to be deployed either in very small embedded servers or to scale to support large numbers of users of much larger servers. In either case, the present invention achieves the important criterion of limiting the server and other resource requirements of the graphics delivery method.

In addition, the invention reduces the size and complexity of the program or script code required to combine the image tiles to create a desired graphic. This is particularly important, whether the user applies the invention to a small or a large environment. The invention preferably allows a server to keep only a single set of image tiles to be used for all colors, for web servers capable of dynamically inserting the color definition into the image as it is being served out by the web server. This feature is most efficiently accomplished through an easily defined color pallet within virtual memory.

The invention dramatically reduces the number of divs or image placement regions required to draw graphics. This is a substantial advantage, since it eases the load on the browser and lets this method scale much better than previous drawing techniques to support large numbers of lines or graphics without overloading the web browser's positioning and rendering capabilities. Further, the invention enables fast and smooth animation of the rendered graphics. For instance, a dynamically updated graph is smoothly drawn and scrolled in real time in response to physical parameters measured and quantified by a small embedded web server.

These and other features and advantages of the invention will be readily apparent to those of skill in the art from a brief review of the following detailed description along with the accompanying drawing figures.

### BRIEF DESCRIPTION OF THE DRAWINGS

FIG. 1 is a schematic drawing of a client/server Web application architecture for tiled line drawing in which the present invention finds application.

FIG. 2 is a schematic drawing of a visual display of the line-drawing system of this invention as shown within a browser.

FIGS. 3A through 3P are schematic drawings illustrating an image tile set for line drawing using image tiles measuring 8×8 (n equals; 7) pixels.

### DETAILED DESCRIPTION OF A PREFERRED EMBODIMENT

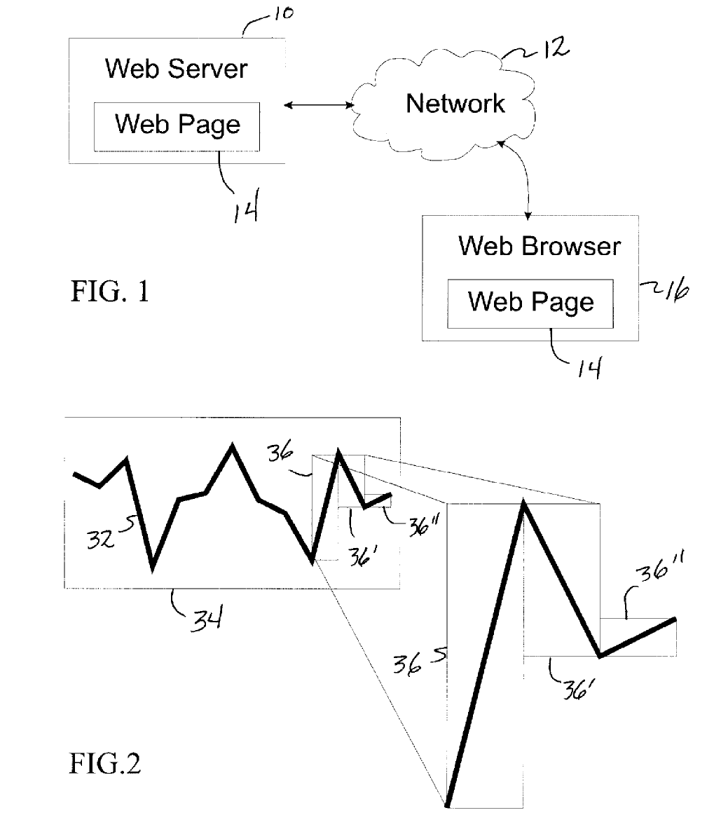

FIG. 1 depicts a common environment in which the present invention finds application. In a typical implementation of the invention, a Web Server 10 is operationally coupled to a network 12, such as for example a world-wide communications network, a local or wide area network, or the like. The Web Server 10, via the network 12, delivers web pages 14 to a web browser 16 using well-known means that are commonly used on Internet technology-based networks. The web page 14 may include by encapsulation or reference multiple components such as HTML/XHTML/DHTML web page code and content, program code (for example JavaScript/ECMAScript), and styling and/or presentation code (for example Cascading Style Sheets(CSS) or XSLT).

Although the method of the present invention finds immediate application in a web browser and the examples shown and described below show this embodiment of the invention, the method is generally applicable to any environment where it is preferable to draw graphics using a small set of pre-defined image tiles.

In operation, the Web Server 10 delivers content, program, and markup code to the web browser 16 over the network 12. Typically, one of the components which is delivered over the network 12 is a browser-based application program or script that is responsible for creating the graphics at the web browser. However, that program or script may reside on a local disk, especially for custom applications that need behavior different from that provided by the server.

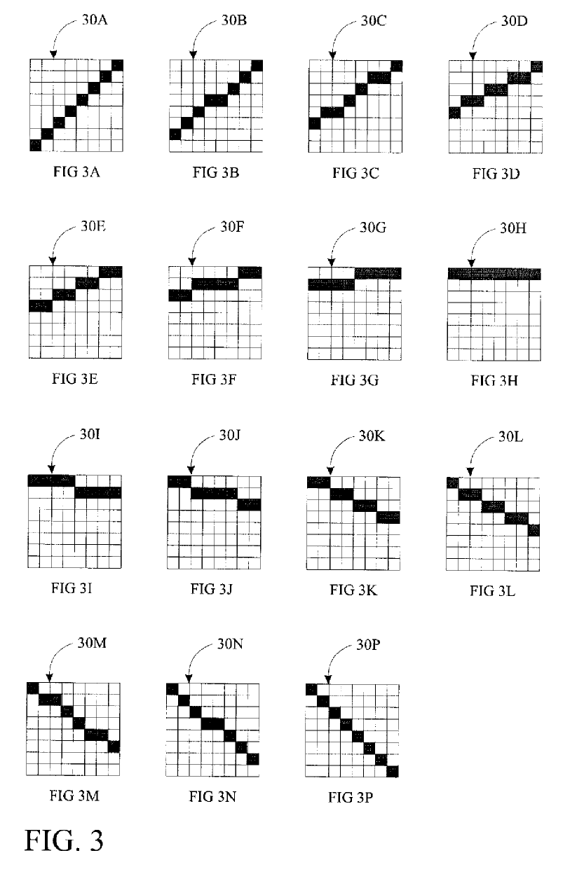

Referring now to FIGS. 2 and 3, in the present invention the application program creates a desired drawing by selecting, positioning, and sizing a series of proper image tiles 30_{X} (where X=A−P), a selection of which is illustrated in FIG. 3A through FIG. 3P. In the example which is to follow, an image or plot 32 is to be developed or drawn within a window 34, which comprises some or all of the available pixel area of a monitor (not shown).

A selected image tile 30_{X} is positioned on a screen or window 34 by encapsulating it in an image region or “DIV” 36 and setting the position of that image region or DIV. For illustration purposes, a set of three DIVs 36, 36′, and 36″ is illustrated in the close-up of FIG. 2. Note that because the segment being graphed has a slope with an absolute magnitude of greater than one, DIVs 36 and 36′ require scaling (stretching) of the proper image tile. (In this case, the proper image tile is the one corresponding to a slope of 1 or −1 as appropriate, since that is the image tile used for drawing any segment with an absolute value of slope of greater than or equal to one.)

Div 36″, by contrast, does not require scaling, because the absolute magnitude of its slope is less than one, so to graph this segment, all that is required is to select and display the correct image tile from 30_{X} corresponding to the desired slope. Note, for example, that the absolute magnitude of the slope of the segment in the image tile 31_{A} (FIG. 3) is 1 (one), while the absolute magnitude of the slope of the segment in the image tile 30_{B} is less than 1 (one).

Preferably, this positioning and resizing operation is performed by setting the properties of the image region or “DIV” through its document object model (DOM) properties from a browser-based application program or script. In suitably capable browsers, it should be possible to use similar methods to resize and reposition an instance of the image tile directly rather than relying on performing these operations on a DIV container for the image tile.

In FIG. 2, an image tile 30_{A} is positioned, aligned, and stretched as required to provide a proper image segment, then an image tile 30_{P} is positioned within the DIV 36′ to form the next contiguous image segment. Then, an image tile 30_{D} is positioned within the DIV 36″, and the process continues. When the entire graph trace has reached the maximum width allowed by the display region 34 (annotations, scales, etc. may reduce the allowable amount to less than the width of the display region), all of the existing DIVs may be shifted to the side and the process continues for the successive segments, allowing the graph to “scroll” across the display area.

As previously described, the invention dramatically reduces the number of divs or image placement regions required to draw graphics, compared to techniques known in the art. For instance, the 8 pixel by 8 pixel image tiles 30 in the example of FIGS. 2 and 3A through 3P, use a single div to do the work that requires up to 7 or 8 divs in other approaches (see www.walterzorn.com and his JavaScript drawing library, which uses a DIV for each pixel in the case of a diagonal line with a slope equal to 1.) This reduction of DIVs dramatically lowers the load on the browser. This reduction of load on the browser is especially beneficial when a number of such animated graphs are shown on a single page, either as completely separate instances, or stacked and synchronized as in a “strip chart” presentation or multiple graph traces overlayed atop one another.

Operation

One application of the technique of the present invention plots time graphs on modern browsers with extremely limited resources, including memory and code space. Among other uses, this is intended for use by embedded devices to produce various kinds of graphically rendered displays and outputs. The present invention may also be used in other applications, such as for example overlays and highlights. These examples should not be construed as limiting of the invention however, since many other applications will be apparent to those of skill in the art. The following is a description of this drawing method applied to time-based graphs, but it can equally well be used to draw other things, for instance, annotations on top of a map that may show the route to be taken, or other types of drawing, such as dials, meters, or direction indicators for indicating a status or value.

A time based graph, such as the plot 32, is typically composed of lines between points equally spaced in the horizontal direction (i.e. equal time intervals), but at varying vertical heights, representing for example time-varying measured values. In a reasonable graph, the horizontal spacing must be a just a few pixels, otherwise the space between the points on the graph will be too wide and lacking in detail. Thus, the problem can be reduced from the general case problem of drawing lines between arbitrary points to drawing lines of arbitrary rise and a fixed run of N pixels, such as 8 pixels in FIG. 3. In other applications, this same logic can be applied to stretch images of a fixed rise across an arbitrary run. The combination of stretching in either direction effectively allows line-drawing between arbitrary points.

A feature of the invention lies in the observation that an image of a line with a slope of exactly 1, when stretched in only one direction by the browser rendering the image, creates an image containing a perfectly drawn line of a different slope. More specifically, vertically stretching such an image N+1 pixels wide and N+1 pixels high (to include both end points) can create a line of any slope greater than 1. Stated differently, such a stretching technique is capable of creating any line with a run of N and a rise of N or greater. All modern browsers can scale images when placing them, and most modern display hardware has hardware assistance for these operations.

Note that squashing images does not usually produce correctly drawn lines, nor does stretching images of slopes other than 1. However, every possible line with a run of N can be drawn using only 2N+1 image tiles. N positively sloped images cover rises from 1 through N, N negatively sloped images cover rises of −1 through −N, and one image covers the horizontal zero-rise case (See FIG. 3H). Rises greater than N or less than −N can be produced by stretching the two diagonal images (riseequals; N and −N), thus covering all possible rises with 2N+1 images. By using images with transparent backgrounds, any number of time based curves can be drawn onto the same graph. In addition, these image tiles may be antialiased using browsers and image formats that support alpha transparency, by defining the antialiasing pixels to be partially transparent.

This method requires only 1 div per line segment (number of points plotted minus one). The code required to place an image and draw a line is extremely small, which is important not only for execution speed, but also because the code is supplied to the browser by a small embedded web server of limited resources. Regardless of the number of points graphed, there are only 2N+1 small (N+1 pixels square), highly compressible, images to be pre-loaded, resulting in minimal requirements for storing the image at the server, transporting it across the network, and caching it at the browser end.

It is possible to combine all of the required image tiles into a single image file, by concatenating them horizontally or vertically, then sliding them in front of the “window” created by the DIV. This method is commonly used in CSS-based navigational menus, and is described as the “sliding doors” technique by Douglas Bowman at http://www.alistapart.com/articles/slidingdoors2/.

In another aspect of the invention, the GET requests for the line images supply a color value in the URL as an argument or as part of the file name. By modifying the color table in the image tiles “on the fly” with the color value argument supplied, a small embedded server can supply the images for lines of any color while only requiring local storage of a single set of 2N+1 small images, either as separate files or as a combined concatenated image as described above.

For example, assume N is 7, with an image tile size of 8 by 8 pixels, as shown in FIG. 3. The last point of each segment overlaps the first point of the next segment for convenience. This is not a requirement of the method; one may begin an adjoining segment with new starting point, if desired. This allows 60 points to span 420 pixels, leaving adequate room for labels and still fitting on a 640 pixel wide screen.

Other criteria may, of course, be selected by the user within the scope and spirit of this invention. The 15 line images with a transparent background in GIF format require only about 50 bytes each, and the script code required to draw a line is approximately two ASCII lines of code. The entire line drawing portion of the system takes under 1 K bytes of server space, and the browser is required to maintain and position far fewer divs than with other methods. Both of these are an improvement over prior art by a factor of several times.

Although the examples given here embody the invention in the context of a web browser, the same basic approach applies in other contexts where direct pixel access is limited or “expensive” from a resource point of view, but the ability to arbitrarily locate and optionally rescale image tiles is available at lower “cost”.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

What is claimed is:

1. A method of drawing a plot on a graphical user interface, comprising the steps of:
a. selecting a first desired image tile of N+1 by N+1 pixels with a first predrawn image on the first image tile, the image having a first starting pixel and a first ending pixel;
b. positioning the selected first image tile at a first desired location on the graphical user interface;
c. if required, stretching the dimensions of the first image tile to match the dimensions of a first selected region of the interface, thereby determining a position on the interface for the first ending pixel;
d. selecting a second desired image tile of N+1 by N+1 pixels with a second predrawn image on the second image tile; the image having a second starting pixel and a second ending pixel;
e. positioning the second image tile with the second starting pixel at the first ending pixel;
f. if required, stretching the dimension of the second image tile to match the dimensions of a second selected region of the interface, thereby determining a position on the interface for the second ending pixel; and
g. continuing the steps of selecting, positioning, and stretching desired image tiles in turn to continue drawing the plot.

2. The method of claim 1, wherein the plot defines one or more colors, and further comprising the step of selectively and dynamically rewriting at least a portion of the color information embedded in the tile images with a web server.

3. The method of claim 1, wherein desired image tiles are concatenated horizontally or vertically and exposed using a sliding doors technique to limit the viewable area of the concatenated image to the region corresponding to the desired single tile image.

4. A system for drawing a plot on a graphical user interface, comprising:
a. means for sequentially selecting desired image tiles of N+1 by N+1 pixels with selected predrawn images, each predrawn image having a starting pixel and a an ending pixel;
b. means for sequentially positioning the selected image tiles at desired locations on the graphical user interface; and
c. means for stretching the dimensions of the image tiles if required to match the dimensions of selected regions of the interface, thereby determining a position on the interface for ending pixels, and thereby developing a contiguous graphical plot.
